(19) United States
(12) Patent Application Publication
(10) Pub. No.: US 2008/0290123 A1
(43) Pub. Date: Nov. 27, 2008

(54) VEHICLE ROOF RACK HAVING A HEIGHT ADJUSTABLE CROSS-MEMBER

(75) Inventor: Glenn Sprague, Brighton, MI (US)

Correspondence Address: DOBRUSIN & THENNISCH PC, 29 W LAWRENCE ST, SUITE 210, PONTIAC, MI, 48342, US

(73) Assignee: Merlynn LLC

(21) Appl. No.: 12/124,542

(22) Filed: May 21, 2008

Related U.S. Application Data
(60) Provisional application No. 60/940,238, filed on May 25, 2007.

(51) Int. Cl. B60R 9/045

(52) U.S. Cl. 224/321

(57) ABSTRACT

A vehicle article carrier apparatus includes a pair of side-rails adapted to be secured in fixed position to the outer top surface of the vehicle in a spaced apart relation to one another and generally parallel to the longitudinal centerline of the vehicle; at least one cross-member spanning generally transversely between the side-rails, the at least one cross-member having opposing ends; and a bracket assembly at the end of each cross member and being slidably connected to the side rails and including a plurality of pivotally connected components configured so that the cross-member has a first lowered position, and the cross-member is moved to a second position that is elevated from outer top surface of the vehicle above the first position, by pivoting about greater than four generally transversely oriented pivotal axes. Methods of use of the article carrier are also disclosed.

### CLAIM OF BENEFIT OF FILING DATE

The present application claims the benefit of the filing date of U.S. Provisional Application Ser. No. 60/940,238 (filed May 25, 2007), and the entirety of the contents of this application being hereby expressly incorporated by reference.

### FIELD OF INVENTION

The present invention relates generally to vehicle article carriers, and more particularly to a vehicle article carrier incorporating a cross-member having several axes of movement resulting in multiple positions of the cross-member relative to the top outer body surface of the vehicle.

### BACKGROUND OF THE INVENTION

Vehicle article carriers (e.g., automotive vehicle roof racks or luggage racks) are used in a wide variety of applications for supporting and securing articles of various sizes above an outer body surface of a vehicle. Typically, such vehicle article carriers include a pair of side-rails that may abut to or may be elevated from the outer body surface. Each side-rail is fixedly secured to the outer body surface of the vehicle in a spaced apart relation to one another so as to extend generally parallel along a substantial longitudinal length of the vehicle. For instance, the side rails may be aligned generally parallel to the longitudinal centerline of the vehicle, wherein the longitudinal centerline bisects the vehicle into left and right sides from the front end the rear end. At least one cross-member, and more typically a pair of cross-members are coupled between the side-rails. Typically, at least one of the cross-members is adjustable so that it can be repositioned along the side-rails so as to better support articles of various sizes.

Currently, there is a height limitation for factory installed article carriers to provide cost effective shipping of the vehicle using a vehicle transporter, more specifically, tractor-trailer vehicles for transporting the vehicle (along with a plurality of other vehicles) from the manufacturer to the dealership. Accordingly, if the height of the vehicle with the article carrier is greater than the height limitation, the vehicle must be transported without the article carrier. If the vehicle is transported without the article carrier, it must be installed once it arrives at the desired location, which has additional costs and less quality assurance. Optionally, vehicles may be required to have reduced roof heights to accommodate for the article carrier and the height limitation, which compromises the comfort of the passenger.

Consequentially, typical vehicle article carriers create aerodynamic drag as well as noise. As a result, the fuel economy and consumption of gas is directly affected by this drag, while the noise may further compromise the comfort of the passenger.

There remains a need for alternative economical approaches to vehicle article carriers, particularly using members that are elevated from the outer body surface of the vehicle.

Efforts at providing luggage racks with adjustable heights are illustrated in the following publications: US2007/0039985; FR 2862584; EP0967119A2; DE 3719974A1; DE 4018009A1; DE 19954835A1; U.S. Pat. No. 6,029,873 all of which are hereby expressly incorporated by reference for all purposes.

### SUMMARY OF THE INVENTION

In general, the present invention meets one or more of the above needs by providing an improved approach to the construction of vehicle article carriers and their method of use. By way of a broad summary, the present invention is directed to an apparatus for the storage articles for a vehicle, comprising a pair of side-rails mounted to an outer top surface (e.g., a roof panel) of the vehicle, at least one cross-member pivotally attached to at least one bracket assembly. That is slidably engageable and pivotally attached to a first side-rail, wherein the cross-member is movable into several positions relative to the outer top surface of the vehicle.

The present invention is directed at an article carrier (and method of its use) configured to raise and lower cross-members of a vehicle roof rack to maximize vehicle roof heights (including minimizing intrusion into the passenger cabin), while minimizing the overall vehicle height. This allows for more headroom within the vehicle while still enabling to ship the vehicle in the most cost effective way. Additionally, aerodynamic drag and noise are reduced without compromising utility or the practicalities of securing a load to the vehicle while traveling on the road. Furthermore, this concept allows for a lower shipping and storage height of the lateral/cross rails on a motor vehicle roof rack, which overcomes the height limitation required by manufacturers for factory-installed roof racks to provide cost effective shipping of the vehicle. The height adjustable concept herein also may allow for securing the cross-members in a lowered position for shipping and increased fuel economy. When needed for hauling or otherwise transporting articles by use of the article carrier by an end user, any of the cross-members of the invention can be raised to elevate the articles from the outer surface of the roof to the desired position relative to the roof, providing the user with choices for the height of the cross-members.

Securing, raising, and moving cross-members of the article carrier herein may be accomplished by releasing a securing mechanism and lifting, dropping, and/or sliding the cross-member to the desired positions and tightening the securing mechanism. It is appreciated that one or more components of the roof rack such as the securing mechanism can provide movement of the cross-member relative to the outer surface of the vehicle, namely the vehicle roof panel. As such, one or more components of the article carrier may be fixed in one position (e.g., permanently affixed in a predetermined position on a vehicle roof panel).

In a first aspect of the invention there is contemplated a vehicle article carrier apparatus located above the outer top surface of the vehicle for supporting articles thereon, the article carrier comprising: a pair of side-rails adapted to be secured in fixed position to the outer top surface of the vehicle in a spaced apart relation to one another and generally parallel to the longitudinal centerline of the vehicle; at least one cross-member spanning generally transversely between the side-rails, the at least one cross-member having opposing ends; and a bracket assembly at the end of each cross member and being slidably connected to the side rails and including a plurality of pivotally connected components configured so that the cross-member has a first lowered position, and the cross-member is moved to a second position that is elevated from outer top surface of the vehicle above the first position, by pivoting about greater than four generally transversely oriented pivotal axes.

The first aspect may be further characterized by one or any combination of the following features: the bracket assembly includes at least one actuating member and a locking component; the bracket assembly includes a forward locking member that includes a forward securing mechanism and a rearward locking member includes a rearward securing mechanism, for defining at least four generally transversely oriented pivot axes within the bracket assembly; one or both of any forward locking member or any rearward locking member has a clevis end that connects it to the bracket assembly; any forward locking member is pivotally attached to the bracket assembly with a generally transversely oriented pin; the first lowered position is such that the cross member substantially abuts the outer top surface of the vehicle; the outer top surface of the vehicle has a substantially continuous surface topography that is substantially devoid of any recesses that would penetrate into the passenger compartment of the vehicle; the bracket assembly is configured for pivotal translation only in a generally longitudinal direction of the vehicle (as shown generally by the arrow in upper left corner of FIG. 1); each cross member is raised or lowered about at least eight pivotal axes; or each bracket assembly is locked in at least two locations to its corresponding side rail.

A second aspect of the invention contemplates a method of using the article carriers herein, and more particularly contemplates a method of transporting a vehicle in an automotive vehicle transporter, comprising the steps of a) loading onto an automotive vehicle transporter a vehicle that includes article carrier apparatus located above the outer top surface of the vehicle for supporting articles thereon, the article carrier including: a pair of side-rails adapted to be secured in fixed position to the outer top surface of the vehicle in a spaced apart relation to one another and generally parallel to the longitudinal centerline of the vehicle; at least one cross-member spanning generally transversely between the side-rails, the at least one cross-member having opposing ends; and a bracket assembly at the end of each cross member and being slidably connected to the side rails and including a plurality of pivotally connected components configured so that the cross-member has a first lowered position, and the cross-member is moved to a second position that is elevated from outer top surface of the vehicle above the first position, by pivoting about greater than four generally transversely oriented pivotal axes; b) lowering the cross-member to the first lowered position; c) transporting the vehicle to a destination while the cross-member is in the first lowered position; and d) raising the cross-member to the second position after reaching the destination.

The second aspect may be further characterized by one or any combination of the following features: wherein the bracket assembly includes at least one actuating member and a locking component, and the lowering and raising steps include raising and lowering the actuating member and locking and unlocking the locking component; the bracket assembly includes a forward locking member that includes a forward securing mechanism and a rearward locking member includes a rearward securing mechanism, for defining at least four generally transversely oriented pivotal axes within the bracket assembly, and the raising and lowering steps include pivoting the cross member relative to the at least four generally transversely oriented pivotal axes; one or both of any forward locking member or any rearward locking member has a clevis end that connects it to the bracket assembly, and the raising and lowering steps include pivoting the cross member relative to the clevis end; any forward locking member is pivotally attached to the bracket assembly with a generally transversely oriented pin, and the raising and lowering steps include pivoting the cross member relative to the pin; the lowering step includes lowering the cross member such that the cross member substantially abuts the outer top surface of the vehicle; the outer top surface of the vehicle is substantially devoid of any recesses that would penetrate into the passenger compartment of the vehicle (e.g., in a manner that would reduce passenger head room in the vehicle, or obstruct visibility), and the lowering of the cross member includes no penetration of any component into a volume defining a passenger compartment; or the bracket assembly is configured as links for pivotal translation only in a generally longitudinal direction of the vehicle, and the raising and lowering steps are substantially free of any transverse pivotal translation of any component; each cross member is raised or lowered about at least eight pivotal axes; or each bracket assembly is locked in at least two locations to its corresponding side rail.

With more particularity, a third aspect of the present invention contemplates a vehicle article carrier apparatus located above the outer top surface of the vehicle for supporting articles thereon, the article carrier including a pair of side-rails adapted to be secured to the outer top surface of the vehicle in a spaced apart relation to one another; at least one cross member extending between the side-rails, the at least one cross member having opposing ends; an actuating member pivotally connected to a first end of the cross-member; the actuating member configured for movement of the at least one cross member; a locking component pivotally connected to the actuating member and slidably attached to a first side-rail, the locking component having: a locked position for securing a first end of the cross-member to a first side-rail; and an unlocked position providing generally linear movement of the first end of the cross-member along the first side-rail; wherein the cross-member has a first position that is substantially abutting the outer top surface of the vehicle; and wherein the cross-member is movable to a second position that is elevated from outer top surface of the vehicle, defining a space therebetween.

This third aspect of the invention may be further characterized by one or any combination of the following features: the linear movement of the cross-member is infinite; the linear movement is incremental; the actuating member includes a first pivotal axis and a second pivotal axis; a portion of the first opposing end of the cross-member is connected to the actuating member between any first and second pivotal axes; the locking component includes a first locking component and a second locking component; any first locking component is pivotally attached to any first pivotal axis of the actuating member; any second locking component is pivotally attached to any second pivotal axis; the first locking component has a third pivotal axis; the second locking component has a fourth pivotal axis; the actuating member and the locking component are located within a bracket; any third pivotal axis is forward of any first pivotal axis; any fourth pivotal axis is rearward of any second pivotal axis; any first locking component has a first securing mechanism that extends along any third pivotal axis; any second locking component has a second securing mechanism that extends along any fourth pivotal axis; the cross member further includes a central axis along the length of the cross-member; the cross member further includes a top surface extending between a forward sidewall and a rearward sidewall, the forward and rearward sidewalls angularly extending downward; any forward sidewall has a forward edge that is approximate to the first pivotal axis; any forward sidewall has a forward edge between any first and third pivotal axes; any rearward sidewall has a trailing edge that is approximate to any second pivotal axis; any rearward sidewall has a trailing edge between any second and fourth pivotal axes; the actuating member is connected to the locking component through a hinge; any bracket employed includes a forward locking component, a rearward locking component, and an actuating member, therebetween; the actuating member has a forward distal end and a rearward distal end that respectively provide pivotal attachments along a first pivotal axis and a second pivotal axis; any forward locking member includes a forward securing mechanism and any rearward locking member includes a rearward locking member, each having a locked position for securing a first end of the cross-member to a first side-rail and an unlocked position providing generally linear movement of the first end of the cross-member along at least one of the side-rails; the forward securing mechanism provides rotational movement for the bracket along a third pivotal axis and any rearward securing mechanism provides rotational movement for the bracket along a fourth pivotal axis; any forward locking member further includes a rearward clevis end and any rearward locking member further includes a forward clevis end; the forward locking member is pivotally attached to any actuating member through any first pivotal axis; any forward distal end is mated with any rearward clevis end and secured by a first pivot pin so that the first pivot pin provides rotational movement for the bracket along any first pivotal axis; any rearward locking member is pivotally attached to any actuating member through any second pivotal axis; any rearward distal end is mated with any forward clevis end and secured by a second pivot pin, any second pivot pin provides rotational movement for any bracket along any second axis; any forward locking member is slidably attached to the first outer rail through any forward securing mechanism; any rearward locking member is slidably attached to any first outer rail through any rearward securing mechanism; the top surfaces of any forward locking member, any rearward locking member, and any actuating member are generally flush with one another; the cross-member is fixedly secured to and generally flush any bracket while orientated in the first position; a side rail includes a outer portion and any elongated channel that are fixedly secured to one another each having a top surface being generally flush with the other; the elongated channel is adapted to receive any forward and rearward locking component; a first guide-rail of the forward securing mechanism and a second guide-rail of the rearward securing mechanism protrude generally transversely from any bracket and are partially disposed within any elongated channel; any first guide-rail and any second guide-rail of the forward and rearward securing mechanism slidably engage any elongated channel; the forward and rearward securing mechanisms are capable of locking the bracket at a plurality of positions along the first outer rail; the forward and rearward securing mechanisms are capable of locking the cross-member at a plurality of positions along a vertical axis; at least one of the forward and rearward securing mechanisms includes a threaded fastener; at least one of the forward and rearward securing mechanisms are a spring loaded pin; the top surface of the outer portion of a side rail extends downward in an arcuate direction so as to become approximate with the outer top surface of the vehicle; a side rail further includes a bottom surface that integrally attached to the top surface and the elongated channel; any bottom surface extends the longitudinal length of the first outer member; at least one portion of the bottom surface is elevated and defines a space between the first outer rail and the outer top surface of the vehicle; the bottom surface of the first outer rail is generally flush with the outer top surface of the vehicle; any elongated channel is generally C-shaped; or any first and second guide-rails of the forward and rearward securing mechanism is generally T-shaped.

According to a fourth aspect of the invention there is contemplated a vehicle article carrier apparatus located above an outer top surface of the vehicle for supporting articles thereon, the article carrier including a pair of side-rails adapted to be secured to the outer top surface in a spaced apart relation to one another; a cross member extending between the side-rails, the cross-member including opposing first and second ends; a bracket attached to the first end of the cross-member, and including a mechanism providing generally vertical movement of the cross-member about at least a first pivot axis, and a second pivot axis, wherein at least one pivot axis is further configured for releasably securing the cross-member to one of the side-rails and for providing generally horizontal movement of the cross-member along that side-rail.

This fourth aspect of the invention may be further characterized by one or any combination of the following features: the first pivoting axis is longitudinally forward of the second pivotal axis, both extending transversely along the bracket; the bracket further includes a third pivoting axis that is forward of a fourth pivoting axis, both extending transversely along the bracket; at least one of the third pivoting axis or the forth pivoting axis is further configured for releasably securing the cross-member to at least one of side-rails and for providing generally horizontal movement of the cross-member along the first side-rail; the first and fourth pivotal axes are configured for releasably securing the cross-member to at least one of the side-rails and for providing generally horizontal movement of the cross-member along that side-rail; or the first and fourth pivotal axis further include a first guide-rail that is slidably engageable with an elongated channel of at least one of the side-rails.

In a fifth aspect of the invention there is contemplated a method for transporting a vehicle having an article carrier, the method comprising the steps of providing a vehicle having an article carrier as described above in one of the first, second, or third aspects of the invention; providing a vehicle transporter; moving the cross member into a first position (e.g., a position that is generally flush with the side-rails and is substantially abutting with the outer top surface of the vehicle); loading the vehicle having the article carrier orientated to the first position into the vehicle transporter; transporting the vehicle having the article carrier from a first location to a second location; unloading the vehicle having the article carrier orientated to the first position from the vehicle transporter; moving the cross member into a second position that is elevated from the first position.

This fifth aspect of the invention may be further characterized by one or more of the following features: after the step of moving the cross-member to the first position, the cross-member is secured using a locking component; prior to the step of moving the cross-member to the second position, a locking component is released from securing the cross-member to the first side-rail; a further step is employed of securing the cross-member to the first side-rail and into the second position using the locking component; a further step is employed of locking one of the forward securing mechanism and the rearward mechanism; a further step is employed of pivoting the cross-member along greater than four (e.g., at least eight) generally transversely disposed pivot axes. The first, second, third, and fourth axes so as to elevate the cross-member from the first position into the second position; a further step is employed of locking the remaining unlocked securing mechanism so as to secure the cross-member in the elevated position.

Any of the features of the above aspects of the invention may be employed as part of any other aspect. For example, aspects of the first and second aspects may be employed in the third, fourth or fifth aspects. Moreover, the first or second aspect of the invention may further be characterized by any of the features of the third, fourth or fifth aspects of the invention.

### BRIEF DESCRIPTION OF THE DRAWINGS

FIG. 1 is a perspective view of one embodiment of the present invention in a lowered position.

FIG. 2 is an enlarged perspective view of the one embodiment of the present invention.

FIG. 3 is a perspective view of the embodiment of FIGS. 1 and 2 in an elevated position.

FIG. 4 is a perspective view of one of the components of the article carrier herein.

FIG. 5 is a perspective view of an illustrative article carrier.

### DETAILED DESCRIPTION OF THE INVENTION

Referring to the drawings, a vehicle article carrier apparatus 10 is located above the outer top surface 12 of a vehicle for supporting articles thereon. Though only one side is shown in some of the drawings, as seen in FIG. 5, the article carrier generally comprises a pair of side-rails 14, one or more cross-members 16, and a bracket assembly 18, therebetween). The side-rails are adapted to be secured (e.g., fixedly or permanently) to the outer top surface of the vehicle generally parallel in a spaced apart relation to one another (see, e.g., FIG. 5).

The side-rails may include an outer portion 20, an inner elongated portion 22 defining a channel, and a shared vertical wall 24 therebetween, which are fixedly attached to one another. The outer portion and the inner elongated channel may include an integral top surface 26 having a first top surface 28 and a second top surface 30 that extend the entire length of the side-rail. The outer portion may include the first top surface that radially extends downward towards a bottom surface 32, and the elongated channel includes the second top surface that is generally parallel to the bottom surface and perpendicular to the shared vertical wall. Additionally, the bottom surface generally extend the entire length of the side-rail and is preferably substantially abutted to the outer top surface of the vehicle (i.e., the outer upper surface of the vehicle's roof panel), however, it is appreciated that portions of the bottom surface may be elevated or spaced apart from the outer top surface of the vehicle.

In one embodiment, the top surface of the side-rail extends downward to the bottom surface in an arcuate direction so as to terminate at the bottom surface and become approximate with the outer top surface of the vehicle. The bottom surface may be integrally attached to the top surface at an outer edge 34 opposite of the shared vertical wall and the elongated channel. An optional seal or gasket may be disposed between the bottom surface 32 and the vehicle top surface 12.

The inner elongated channel defined in portion 22 is configured for slidable engagement of the bracket assembly and further includes an upper edge 36 and a lower edge 38 in a spaced apart relation, which may be extending from the top and bottom surfaces, respectively. More specifically, the upper edge may extend downward from the top surface, the lower edge may extend upward from the bottom surface with the shared vertical wall, therebetween, which together define a generally C-shaped elongated channel. In one embodiment, the elongated channel is adapted to receive the bracket assembly and is configured to allow the bracket assembly to slide along the elongated channel while in an unlocked position. The article carrier may optionally employ end caps or other structure at one or both of the ends of the side rails for restricting longitudinal motion of the bracket assembly.

The bracket assembly includes an actuating member 40 that is pivotally connected to the cross-member for movement thereof and a locking component 42 that is configured to secure the bracket assembly to the elongated channel. Accordingly, the locking component includes a locked position for securing the bracket assembly and the cross-member to the side-rail and an unlocked position that provides generally linear movement of bracket assembly and the cross-member along the side-rail.

The locking component includes a forward locking member 44 and a rearward locking member 46. The locking members and the actuating members are effectively configured as longitudinally extending links. The forward locking member is located forward of the actuating member and is pivotally attached thereto through a first pivotal axis. The rearward locking member is located rearward of the actuating member and is pivotally attached thereto through a second pivotal axis. The pivotal axes provide rotational movement of the cross-member. The pivotal axes are generally transversely oriented. As can be seen, each bracket assembly will have more than two pivotal axes (e.g., a threaded nut having a dimension larger than the channel opening into which a bolt such as a threaded bolt 52 may be inserted), and more preferably at least 4 pivotal axes.

Furthermore, the forward locking member includes a first securing mechanism located along a third pivotal axis with the third pivotal axis being generally parallel to and located forward of the first pivotal axis. The first securing mechanism extends generally transversely along the forward locking member and has a first locking portion that extends outward of the forward locking member to the elongated channel. The first locking portion 50 is partially disposed within a first engagement portion of the elongated channel for slidable engagement, therein.

Similarly, the rearward locking member may include a second securing mechanism located along a fourth pivotal axis, with the fourth pivotal axis being generally parallel to and located rearward of the second pivotal axis. The second securing mechanism extends generally transversely along the rearward locking member and has a second locking portion that extends outward of the rearward locking member to the elongated channel. The second locking portion 50 is partially disposed within a second engagement portion of the elongated channel for slidable engagement therein.

In one embodiment, at least one of the third pivoting axis or the fourth pivotal axis is further configured for releasably securing the cross-member to the elongated channel of the side-rail. Furthermore, at least one of the third or fourth pivotal axes provide radial movement of the cross-member in a generally vertical direction and a generally linear movement along the elongated channel.

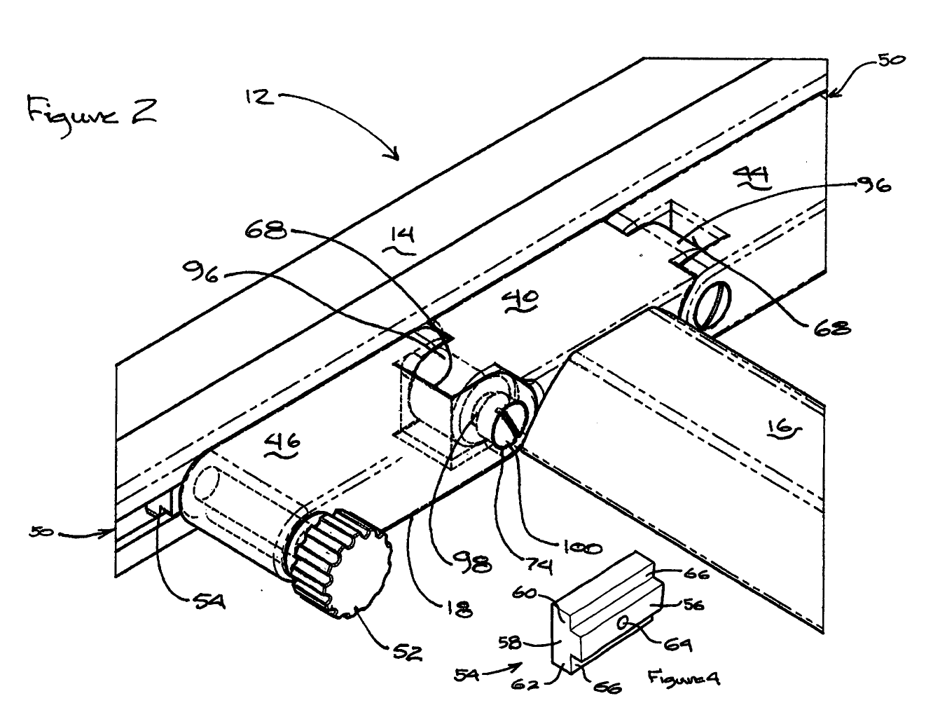

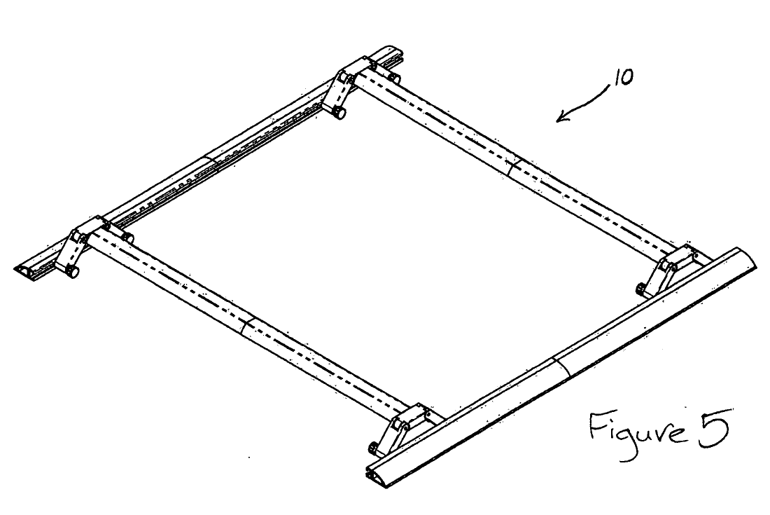

The first and second locking portions 50 portions extend outward of the locking members 44 and 46 and into the elongated channel of the side-rail. The first and second locking portions include a generally T-shaped member 54 (see FIG. 4) that includes an inner portion 56 extending from the locking member to a generally vertical outer wall portion 58 having an upper flange 60 and a lower flange 62. A threaded hole 64 may be defined in the locking portion to receive the bolt 52. The upper and lower flanges each have an inner surface 66 generally approximate to the upper and lower edges of the elongated channel, respectively. Preferably, the T-shape of the locking portions and the C-shape of the elongated channel are configured to mate with one another for slidable engagement. Accordingly, as mentioned herein, the bracket assembly is configured for the linear movement along the side-rail, such linear movement may include infinite movement, incremental movement, or otherwise. It can be clamped in place by tightening the locking portion against the side rail, such as by twisting the bolt 52 relative to the T-shaped member 54. It is seen in FIG. 2 how the member 54 may have a stepped configuration so that it has at least two contact surfaces (e.g., orthogonally disposed relative to each other) for contacting the side rail.

The forward and rearward locking members 44 and 46 may further include attachment linkage to the actuating member. For example, with reference to FIG. 2, the forward locking member may include a first clevis end 68 located rearward of the first securing mechanism along the third pivotal axis. The rearward locking member may include a second clevis end 70 located forward of the second securing mechanism along the forth pivotal axis. The first and second clevis ends may have outer portions extending longitudinally towards the actuating member. The outer portions 72 form a U-shaped valley at the respective end of the forward and rearward locking members that are adapted to receive an interconnecting member. The outer portions include transversely extending cavities 74 that are adapted for attachment and rotational movement of the attached members.

Though shown in the drawings in partial section, it will be appreciated that the one or more cross-members typically will have a length sufficient to substantially span the distance separating the side-rails, particularly taking into account the bracket assembly that connects the cross-members to the side rails (as in FIG. 5). The cross-member extends transversely across the outer top surface of the vehicle and includes a top wall 76, a bottom wall 78, and forward and rearward sidewalls 80 and 82, respectively, therebetween. The forward sidewall and the rearward sidewall extend downward from the top wall to the bottom wall forming a forward edge 84 and a trailing edge 86, respectively. The cross-member further includes opposing ends 88, which connect the cross-member to the opposing bracket assemblies generally along its center axis.

In one embodiment, the forward sidewall has a forward edge that is generally parallel to and located approximate to the first pivotal axis. In another embodiment, the forward sidewall has a forward edge that is generally parallel to and located between the first and third pivotal axes. In another embodiment, the rearward sidewall has a trailing edge that is generally parallel to and located approximate to the second pivotal axis. In yet another embodiment, the rearward sidewall has a trailing edge that is generally parallel to and located between the second and fourth pivotal axes.

The cross-member is connected to the bracket assembly through the actuating member. In a preferred embodiment, the cross-member is fixedly secured to the actuating member, however, it is appreciated that the cross-member may be releaseably attached, pivotally attached, or otherwise to the actuating member.

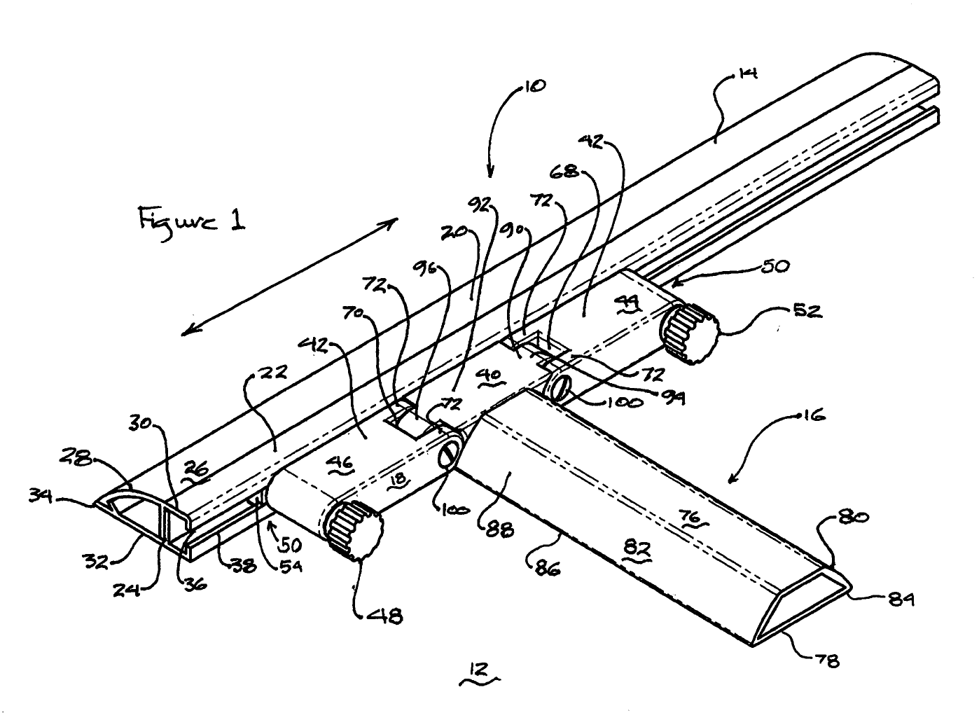

As mentioned previously, the bracket assembly may include an actuating member configured for movement of the cross-member. As seen in FIG. 1, the actuating member may include a forward portion 90 and a rearward portion 92 having a first pivotal axis and a second pivotal axis, respectively that provide radial movement for the cross-member. The cross-member has a central axis along its length that interconnects the actuating member between the first and second pivotal axes, wherein the first pivotal axis may be positioned forward of the second pivotal axis.

The forward and rearward portions of the actuating member may further include attachment linkage, not only to provide rotational movement, but also to enable the actuating member to attach to the locking component, more specifically, the first and second locking members. Accordingly, in one embodiment, the forward and rearward portions of the actuating member may include a forward distal end 94 and a rearward distal end 96, respectively. Shown in FIG. 2, the forward and rearward distal ends may have one or more cavities 98 extending generally transversely across the actuating member and when inserted, respectively, into the first and second clevis ends of the forward and rearward locking members, they are in alignment with the outer portion cavities of the clevis ends.

A distal end is respectively mated with the clevis end and secured by a pivot mechanism such as a pin 100 or other suitable fastener (it is recognized that the pivot axes herein are defined at the locations of elements 48, 52 and 100, as depicted). The pin may have a threaded distal end that is threaded into or onto the locking member. Accordingly, the interconnection of the actuating member and a locking component through the pivot mechanism provides rotational movement for the bracket assembly along the respective pivotal axis. More specifically, the clevis ends of the forward and rearward locking members are pivotally attached to the distal ends of the actuating member through the pivot pin and the first and second pivotal axes, respectively. It will be appreciated that the structure depicted could be reversed such that the clevis ends are located instead on the actuating member.

In view of the foregoing, in the cross-member can be secured to the side-rail and into the different positions through the bracket assembly such as by using the locking component. The locking component may include a forward locking member and a rearward locking member, located forward and rearward of the actuating member, respectively. The forward and rearward locking members may include a securing mechanism that has a portion partially disposed within the elongated channel for slidable engagement. The securing mechanisms may further provide rotational movement of the bracket assembly along a third and fourth pivotal axis. The forward and rearward locking members may further include a clevis end for pivotal attachment to the actuating member. The clevis end may be located on an opposing end of the locking member, opposite of the securing mechanism. The actuating member (which may be as simple as an end piece such as an end cap for the cross member) may further includes a forward distal end and a rearward distal end that interconnect with the respective clevis end of the forward and rearward locking members. The clevis end may be pivotally attached to the distal end for radial movement of the bracket assembly and the cross-member along a first pivotal axis and a second pivotal axis, respectively.

Pivoting about the pivotal axes may be achieved by use of a space between any pin or other fastener and the inside wall of the linking components of components 44, 46, or 96. A bushing may be used as part of any linkage. A fastener having threads omitted (or which otherwise provides a bearing surface) from a bearing portion of the fastener may be used.

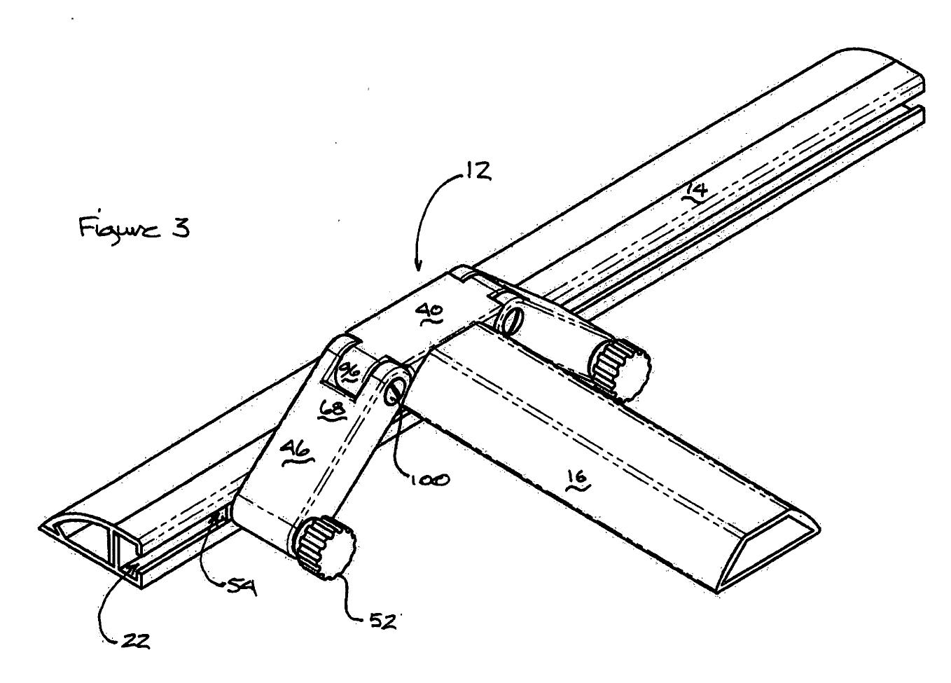

Types of securing mechanisms include handles, knobs, cam locks, over center draw latches, threaded fasteners, spring loaded pins, or otherwise. Though a nut and bolt assembly is depicted (thereby allowing for infinite adjustment), it is possible that locking pins may engage apertures located along the lengthy of the side rails for intermittent adjustment (see, e.g., U.S. Pat. No. 5,474,217 (Mandarino et al.) incorporated by reference). The forward and rearward securing mechanisms are capable of securing the bracket assembly into a plurality of locations longitudinally along the outer side-rail. Additionally, the securing mechanisms are configured to secure the cross-member at a plurality of positions along a vertical axis. More specifically, the securing mechanism, when unlocked, enables radial movement of the cross-member from a first position, (FIG. 1), that is substantially abutting the outer top surface of the vehicle to a second position, (FIG. 3), that is elevated from outer top surface of the vehicle, thereby having a spaced apart relation to one another. As discussed previous, the radial movement is accomplished using one or more pivotal axes. For example, to raise and lower the cross member of the embodiment of FIGS. 1-3, eight pivotal axes are employed (four associated with each bracket).

While orientated in the first position the top surfaces of the side-rails, the bracket assembly, and the one or more cross-members may be generally flush with one another. The cross-member may be fixedly secured to and generally flush with the bracket assembly while orientated in the first position. The outer portion of side-rail and the elongated channel may be secured to one another each having a top surface being generally flush with the other as in FIGS. 1 and 2. The bottom surface of the outer side-rails may be generally abutted to the outer top surface of the vehicle as in FIGS. 1 and 2. FIG. 3 illustrates an elevated position.

In view of the forgoing, it is appreciated that one or more components of the vehicle article carrier is formed from materials such as metal, (steel, aluminum, or otherwise), plastic, or otherwise and combinations thereof. Additionally, it is appreciated that one or more components may be formed using methods such as extrusion, pull-extrusion, molding, blow-molding, hot-forming, cold-forming, roll-forming, hydro-forming, stretch-forming, stamping, or otherwise. Typically the ends of the side rails are terminated and closed off by using a decorative element cap. In certain applications, the cross rail may terminate in a similar manner.

Typical vehicle transporters transport one or more vehicles, preferably several vehicles, from one location to another. Vehicles having article carriers may be restricted by size requirements of the vehicle transporters due to the added height of the vehicle carriers. Accordingly, as discussed previously, the bracket assembly is configured for movement of the cross-member. More specifically, the bracket assembly is configured for elevating the cross-member from a first position that may be generally flush with the side-rails and substantially abutting the outer top surface of the vehicle to second position that is elevated from the first position. Advantageously, the first or lowered position of the cross-member enables a vehicle having an article carrier to be relocated using a vehicle transporter.

While orientated in the first position, the first and second securing mechanisms of the forward and rearward locking members may be locked, thereby securing the cross-member in position. The first and second securing mechanisms prevent the cross-member from linearly sliding along the elongated channel and/or elevating to the second position or positions therebetween.

After the vehicles having the article carrier is transported and removed from the vehicle transporter, the article carrier, more specifically, the cross-member can be elevated to the second position, for use thereof. To orientate the cross-member into the second position, one or both securing mechanisms are unlocked and the cross-member is elevated to the desired height. If only one locking component is unlocked, the unlocked locking component is slid towards the locked locking component while the operator raises the cross-member. Once the cross-member is elevated to the desired height, the unlocked locking component is locked, thereby securing the cross-member in place. However, if both locking components are unlocked, the cross-member assembly is additionally capable of linear movement along the elongated channel of the side-rails. Once the cross-member is linearly positioned in the desired location along the elongated channel, one of the securing mechanisms is locked and the cross-member is elevated and secured by locking the remaining unlocked securing mechanism as discussed above. Accordingly, as the cross-member is elevated or lowered to the desired position, the actuating member rotates along at least one of the first and second pivotal axes, while the forward and rearward locking members rotate along at least one of first, second, third, and fourth pivotal axes.

In one method of operation, a vehicle having an article carrier positioned about an outer top surface of the vehicle is provided. The article carrier of the vehicle includes a pair of side-rails adapted to be secured to the outer top surface in a spaced apart relation to one another, a cross-member that spans between and including opposing ends, and a height and fore/aft adjustable bracket at the ends of the cross member, the adjustable brackets each including at least four pivotal axes that are generally transversely disposed. The article carrier is operated to move the cross member in the fore/aft direction, a raised position or a lowered position.

The methods of the invention may be characterized as providing a vehicle transporter configured for transporting vehicles from one location to another, wherein the vehicle transporter includes a cargo space adapted to store vehicles. The cross-member of the article carrier described herein is moved into a first position that is generally flush with the side-rails and is substantially abutting with the outer top surface of the vehicle. The vehicle, while having the article carrier orientated to the first position, is loaded into the vehicle transporter. The vehicle having the article carrier (e.g., orientated to the first position) is transported from a first location to a second location. The vehicle, while still having the article carrier orientated to the first position, is unloaded from the vehicle transporter. The locking component may be unlocked from securing the cross-member in the first position to the first side-rail. The cross-member may be moved linearly along the elongated channel to a desired position longitudinally about the outer top surface of the vehicle. A first locking member of the locking component may be locked to secure the cross-member along the elongated channel. The cross-member may be moved into a second position that is elevated from the first position. A second locking member of the locking component may be locked, thereby securing the cross-member in the second position that is elevated from the first position.

As will be appreciated from the teachings in the written description above, particularly taking into consideration the accompanying drawings, the article carriers of the invention herein (including but not limited to any of the article carriers summarized herein with respect to the first, second or third aspects of the invention) may be further characterized by one or any combination of the following features: the cross-member may be raised or lowered without pivoting any component about an axis that is generally parallel to the longitudinal axis of the article carrier side rails, without pivoting any component toward the vehicle longitudinal centerline, or both; the cross-member may be raised or lowered only by pivotal movement about at least two pivot axes (e.g., at least two of the first or second pivot axes, or third or fourth pivot axes that are longitudinally spaced apart from each other, are generally parallel to each other, or both); the cross-member may be raised or lowered without sliding it relative to any support member such as a stanchion or bracket; the article carrier requires no transverse channels in a vehicle roof panel into which the cross-member can be lowered into (although, it is possible to include such a channel into which the cross-member is raised or lowered); the article carrier herein can be infinitely adjustable between its lower most position and its upper most position; the article carrier herein can be adjusted so that the upper surface of one or more cross-member is inclined at an angle relative to an upper outer surface the roof panel; the article carrier herein may be adjusted so that the upper surface of one or more cross-member is generally parallel to the upper outer surface of the roof panel; throughout the raising or lowering of the cross-member, the side rails may remain in a fixed position relative to the vehicle roof, and may not be raised or lowered; the roof panel may be free of any cavity or other recess into which any component of the article carrier is raised or lowered; the cross-member may be raised or lowered without a motor, without a pulley, without a lever member or any combination thereof; or the raising or lowering of each rail may require pivoting about at least eight different pivot axes (e.g., four pivot axes per each side rail).

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only three of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A vehicle article carrier apparatus located above the outer top surface of the vehicle for supporting articles thereon, the article carrier comprising:
a pair of side-rails adapted to be secured in fixed position to the outer top surface of the vehicle in a spaced apart relation to one another and generally parallel to the longitudinal centerline of the vehicle;
at least one cross-member spanning generally transversely between the side-rails, the at least one cross-member having opposing ends; and
a bracket assembly at the end of each cross member and being slidably connected to the side rails and including a plurality of pivotally connected components configured so that the cross-member has a first lowered position, and the cross-member is moved to a second position that is elevated from outer top surface of the vehicle above the first position, by pivoting about greater than four generally transversely oriented pivotal axes.

2. The apparatus of claim 1, wherein the bracket assembly includes at least one actuating member and a locking component.

3. The apparatus of claim 2, wherein the bracket assembly includes a forward locking member that includes a forward securing mechanism and a rearward locking member includes a rearward securing mechanism, for defining at least four generally transversely oriented pivot axes within the bracket assembly.

4. The apparatus of claim 3, wherein one or both of the forward locking member or the rearward locking member has a clevis end that connects it to the bracket assembly.

5. The apparatus of claim 4, wherein the forward locking member is pivotally attached to the bracket assembly with a generally transversely oriented pin.

6. The apparatus of claim 5, wherein the first lowered position is such that the cross member substantially abuts the outer top surface of the vehicle.

7. The apparatus of claim 1, wherein the outer top surface of the vehicle is substantially devoid of any recesses that would penetrate into the passenger compartment of the vehicle.

8. The apparatus of claim 6, wherein the outer top surface of the vehicle is substantially devoid of any recesses that would penetrate into the passenger compartment of the vehicle.

9. The apparatus of claim 1, wherein the bracket assembly is configured as links for pivotal translation only in a generally longitudinal direction of the vehicle.

10. The apparatus of claim 8, wherein the bracket assembly is configured for pivotal height adjusting translation only in a generally longitudinal direction of the vehicle.

11. A method of transporting a vehicle in an automotive vehicle transporter, comprising the steps of;
a) loading onto an automotive vehicle transporter a vehicle that includes article carrier apparatus located above the outer top surface of the vehicle for supporting articles thereon, the article carrier including:
a pair of side-rails adapted to be secured in fixed position to the outer top surface of the vehicle in a spaced apart relation to one another and generally parallel to the longitudinal centerline of the vehicle;
at least one cross-member spanning generally transversely between the side-rails, the at least one cross-member having opposing ends; and
a bracket assembly at the end of each cross member and being slidably connected to the side rails and including a plurality of pivotally connected components configured so that the cross-member has a first lowered position, and the cross-member is moved to a second position that is elevated from outer top surface of the vehicle above the first position, by pivoting about greater than four generally transversely oriented pivotal axes;
b) lowering the cross-member to the first lowered position;
c) transporting the vehicle to a destination while the cross-member is in the first lowered position; and
d) raising the cross-member to the second position after reaching the destination.

12. The method of claim 11, wherein the bracket assembly includes at least one actuating member and a locking component, and the lowering and raising steps include raising and lowering the actuating member and locking and unlocking the locking component.

13. The method of claim 12, wherein the bracket assembly includes a forward locking member that includes a forward securing mechanism and a rearward locking member includes a rearward securing mechanism, for defining at least four generally transversely oriented pivotal axes within the bracket assembly, and the raising and lowering steps include pivoting the cross member relative to the at least four generally transversely oriented pivotal axes.

14. The method of claim 13, wherein one or both of the forward locking member or the rearward locking member has a clevis end that connects it to the bracket assembly, and the raising and lowering steps include pivoting the cross member relative to the clevis end.

15. The apparatus of claim 14, wherein the forward locking member is pivotally attached to the bracket assembly with a generally transversely oriented pin, and the raising and lowering steps include pivoting the cross member relative to the pin.

16. The apparatus of claim 15, wherein the lowering step includes lowering the cross member such that the cross member substantially abuts the outer top surface of the vehicle.

17. The method of claim 11, wherein the outer top surface of the vehicle is substantially devoid of any recesses that would penetrate into the passenger compartment of the vehicle, and the lowering of the cross member includes no penetration of any component into a volume defining a passenger compartment.

18. The method of claim 16, wherein the outer top surface of the vehicle is substantially devoid of any recesses that would penetrate into the passenger compartment of the vehicle, and the lowering of the cross member includes no penetration of any component into a volume defining a passenger compartment.

19. The method of claim 11, wherein the bracket assembly is configured for pivotal translation only in a generally longitudinal direction of the vehicle, and the raising and lowering steps are substantially free of any transverse pivotal translation of any component.

20. The method of claim 18, wherein the bracket assembly is configured for pivotal translation only in a generally longitudinal direction of the vehicle, and the raising and lowering steps are substantially free of any transverse pivotal translation of any component.
